(19) United States
(12) Patent Application Publication
(10) Pub. No.: US 2003/0202005 A1
(43) Pub. Date: Oct. 30, 2003

(54) Information playback apparatus and information playback method

(75) Inventor: Takashi Sadahiro, Tokyo (JP)

Correspondence Address: SUGHRUE MION, PLLC, 2100 PENNSYLVANIA AVENUE, N.W., WASHINGTON, DC, 20037, US

(73) Assignee: MITSUBISHI DENKI KABUSHIKI KAISHA

(21) Appl. No.: 10/421,695

(22) Filed: Apr. 24, 2003

(30) Foreign Application Priority Data
Apr. 26, 2002 (JP) 2002-126893

(51) Int. Cl. G09G 5/00

(52) U.S. Cl. 345/716

(57) ABSTRACT

An information playback apparatus includes an information playback unit for playing back information, a video display unit for displaying images associated with the played back information, and a sound output unit for outputting sound associated with the played back information. It also includes a put-on detector for detecting that a user puts on the sound output unit such as headphones or earphones. In response to the detection, it automatically opens the screen of the video display unit, and starts reproduction of the information to display images and output sound.

### BACKGROUND OF THE INVENTION

1. Field of the Invention

The present invention relates to an information playback apparatus, and more particularly to an information playback apparatus and information playback method for a back seat passenger on a vehicle to watch images and hear sounds of a television, VTR (Video Tape Recorder), DVD (Digital Video Disc), car navigation system and the like.

2. Description of Related Art

Conventionally, an information playback apparatus as shown in FIG. 9 is known. It includes a back-seat display 2 mounted at a position visible from a back seat passenger 6 sitting on a back seat 1 of a vehicle. The back-seat display 2 is connected to a video playback system such as a television tuner, VTR player, DVD player, car navigation system and the like, which can be integrated into the back-seat display 2. Thus, the back seat passenger 6 can enjoy various images and sounds.

As shown in FIG. 10, the back-seat display 2 comprises a housing 2a attached to the ceiling, and a screen 2b mounted on a shaft 5 in such a manner that it can be opened and closed. When not used, the screen 2b is contained in the housing by rotating it in the direction of an arrow 8, and is opened only when it is used.

The sound from the back-seat display 2 is transmitted to headphones (or earphones) 3 by a wired or wireless device as shown in FIG. 10. In addition, selection of the playback images the back-seat display 2 displays, channel switching of the television, and operation of the DVD playback are carried out by a remote control 7 or buttons on the control panel on the back-seat display 2.

The back-seat display 2 can be mounted in various ways other than suspended from the ceiling as shown in FIG. 10. For example, it can be embedded into a headrest for a front-seat passenger or into a back of a front-seat. Alternatively, it can be a stationary type placed on a console box or on the floor. Whatever types it may be, it is put away to be kept out of the way when it is not used, and is opened only when it is used. The passenger 6 sets the screen 2b at a location easily visible to him or her, and carries out the selection of the playback images, channel switching, angle and position control of the screen and volume control of the sound.

The conventional information playback apparatus has a problem in that it is cumbersome and inconvenient for the passenger 6 to carry out the setting of the screen 2b, and the various operation such as the selection, switching and control every time he or she enjoys the images.

### SUMMARY OF THE INVENTION

The present invention is implemented to solve the foregoing problems. It is therefore an object of the present invention to provide an information playback apparatus and information playback method enabling the display unit to be opened or closed automatically in response to wearing of the headphones (or earphones) by the user.

Another object of the present invention is to provide an information playback apparatus and information playback method enabling a user to carry out the selection of playback images, channel switching, angle and position control of the screen, volume control, and operation for communication with the outside on the side of the headphones (or earphones).

According to a first aspect of the present invention, there is provided an information playback apparatus including put-on detection means for detecting wearing of sound output means by a user, and for outputting a put-on detection signal, wherein information playback means starts playback of the information in response to the put-on detection signal. It offers an advantage of being able to start the information playback means automatically, and to save the user from carrying out operation.

Further, it may include open/close means for opening and closing the screen of video display means; and control means for controlling the open/close means in response to the put-on detection signal. It offers an advantage of being able to save the user from carrying out open and close operation of the screen every time he or she enjoys a video program.

In addition, it may display on the video display means the contents of an incoming call via external communication means such as a mobile phone. It offers an advantage of being enabling the user to aware of the arrival of the incoming call to the mobile phone without fail even during enjoying the video program.

According to a second aspect of the present invention, there is provided an information playback method including the steps of detecting putting on of sound output means by a user and outputting a detection signal; and starting playback of the information in response to the detection signal. It offers an advantage of being able to save the user from carrying out operation.

### BRIEF DESCRIPTION OF THE DRAWINGS

FIG. 1 is a schematic diagram illustrating an embodiment 1 of the information playback apparatus in accordance with the present invention;

FIG. 2 is a block diagram showing a configuration of the back-seat display of the embodiment 1 of the information playback apparatus;

FIG. 3 is an external view of the headphones of an embodiment 2 of the information playback apparatus in accordance with the present invention;

FIG. 4 is a block diagram showing a circuit configuration of the headphones of the embodiment 2 of the information playback apparatus;

FIG. 5 is a block diagram showing a configuration of the back-seat display of the embodiment 2 of the information playback apparatus;

FIG. 6 is a block diagram showing a configuration of a vehicle back-seat video apparatus of an embodiment 3 of the information playback apparatus in accordance with the present invention;

FIG. 7 is a block diagram showing a circuit configuration of the headphones of the embodiment 3;

FIG. 8 is a block diagram showing a configuration of the back-seat display of the embodiment 3;

FIG. 9 is a diagram showing a vehicle including a conventional information playback apparatus; and

FIG. 10 is a diagram illustrating the conventional information playback apparatus.

### DETAILED DESCRIPTION OF THE PREFERRED EMBODIMENTS

The invention will now be described with reference to the accompanying drawings.

Embodiment 1

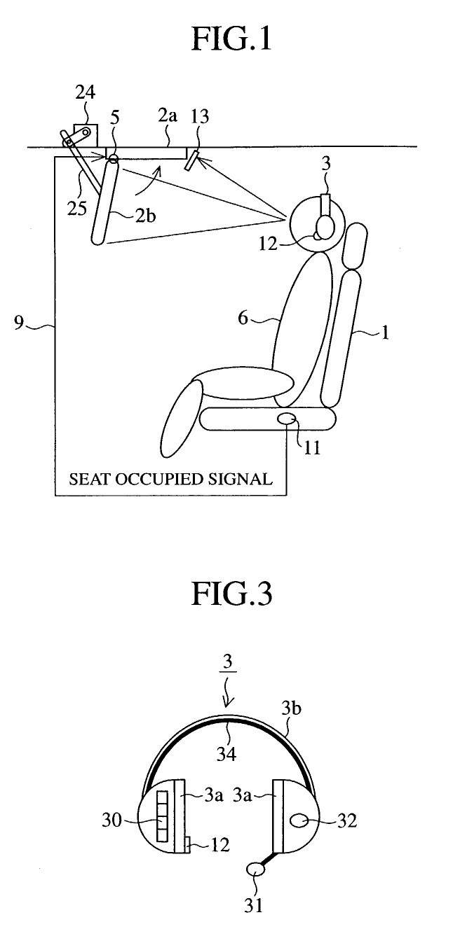

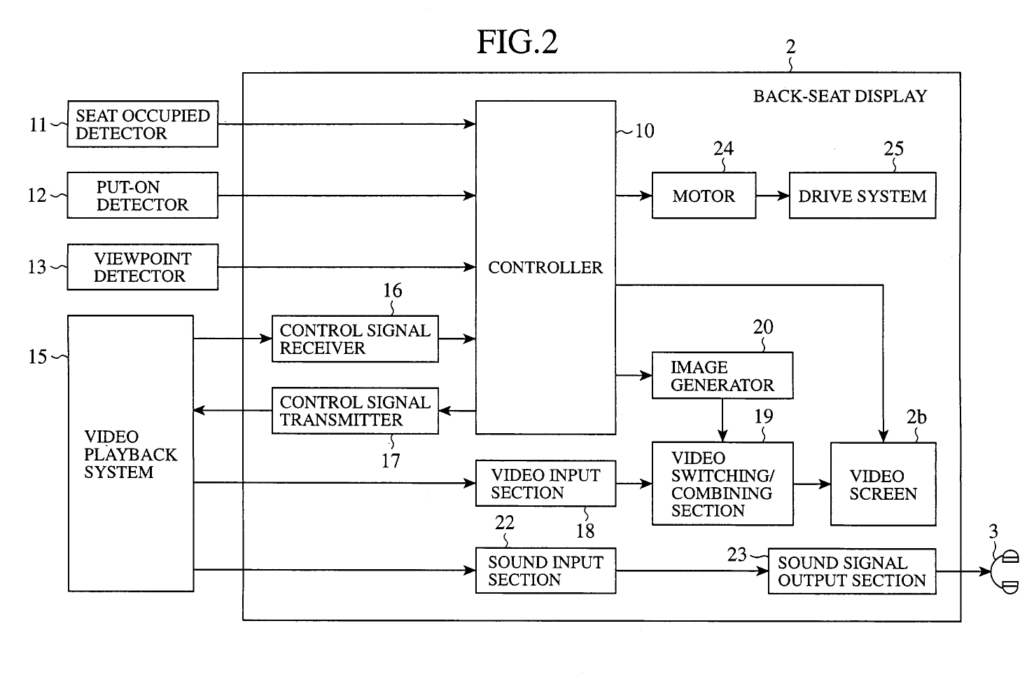

FIG. 1 is a schematic diagram showing an embodiment 1 in which an information playback apparatus in accordance with the present invention is applied to a back-seat video apparatus of a vehicle; and FIG. 2 is a block diagram showing a configuration of a back-seat display. The same reference numerals as those of FIG. 10 designate the same or like portions.

In FIG. 1, the reference numeral 11 designates a seat occupied detector such as a switch mounted on a back seat 1 for sending a seat occupied detection signal to a back-seat display 2 via a conductor 9 (or by wireless) when a passenger 6 sits on the back seat 1. A plurality of such seat occupied detectors are mounted in the longitudinal direction of the back seat 1 to detect the seated position.

The reference numeral 12 designates a put-on detector such as a switch mounted on the headphones 3 for detecting that the passenger 6 puts on the headphones 3, and for sending the detection signal to the back-seat display 2 by a wired or wireless means. The reference numeral 13 designates a viewpoint detector for detecting the point of view of the passenger 6 by means of an image pickup device or the like. It sends its detection signal to the back-seat display 2 via a wired or wireless line. The reference numeral 24 designates a motor for driving the back-seat display 2, and 25 designates a drive system for driving the back-seat display 2, to which a desired system such as a link mechanism or gear train is applied.

FIG. 2 is a block diagram showing a configuration of the back-seat display 2 of the present embodiment 1.

In FIG. 2, the reference numeral 10 designates a controller of the back-seat display 2 supplied with the signals from the seat occupied detector 11, put-on detector 12, viewpoint detector 13, and video playback system 15. The reference numeral 16 designates a control signal receiver for receiving the control signal from the video playback system 15; and 17 designates a control signal transmitter for transmitting the control signal to the video playback system 15. The control signal receiver 16 receives the control signal indicating the state in which a DVD player as the video playback system 15 is placed. The control signal transmitter 17 transmits from the back-seat display 2 the signal for controlling the DVD player, such as a command for changing the track of the DVD. The reference numeral 18 designates a video input section; 19 designates a video switching/combining section, 20 designates an image generator, 22 designates a sound input section, and 23 designates a sound signal output section. The video playback system 15 can be a TV tuner or VTR playback other than the DVD player.

Next, the operation of the present embodiment 1 will be described.

The seat occupied detector 11 detects that the passenger 6 sits on the back seat 1, and detects his or her seated position as well. The viewpoint detector 13 detects the point of view of the passenger 6, and the put-on detector 12 detects that the passenger 6 wears the headphones 3. The detection signals of the seat occupied detector 11, put-on detector 12 and viewpoint detector 13 are supplied to the controller 10.

Receiving the control signals, the controller 10 decides the optimum angle and position of the screen 2b and the optimum brightness and contrast of the images on the screen for the passenger 6, and adjusts them automatically. Specifically, it drives the drive system 25 of the back-seat display 2 with controlling the motor 24, thereby opening the screen 2b, and adjusting the angle and position of the screen 2b. In addition, it adjusts the brightness, contrast and the like of the images on the screen of the screen 2b by controlling the video switching/combining section 19 via the image generator 20.

Embodiment 2

FIGS. 3-5 are diagrams showing an embodiment 2 of the information playback apparatus 2 in accordance with the present invention.

FIG. 3 shows an external view of the headphones 3. In FIG. 3, the reference numeral 30 designates a set of operation switches mounted on one of sound production sections 3a; 31 designates a microphone; and 32 designates a transceiver for transmitting a voice signal output from the microphone 31, and for receiving the sound signal from the back-seat display 2. The transceiver is composed of an infrared ray emitting and receiving device or a wireless transmitting and receiving device. The reference numeral 34 designates an antenna mounted along a headband 3b for transmitting signals from the operation switches 30 and put-on detector 12 to the back-seat display 2 by wireless. The put-on detector 12 is mounted on a specified place on one of the sound production sections 3a or on the headband 3b linking the two sound production sections 3a.

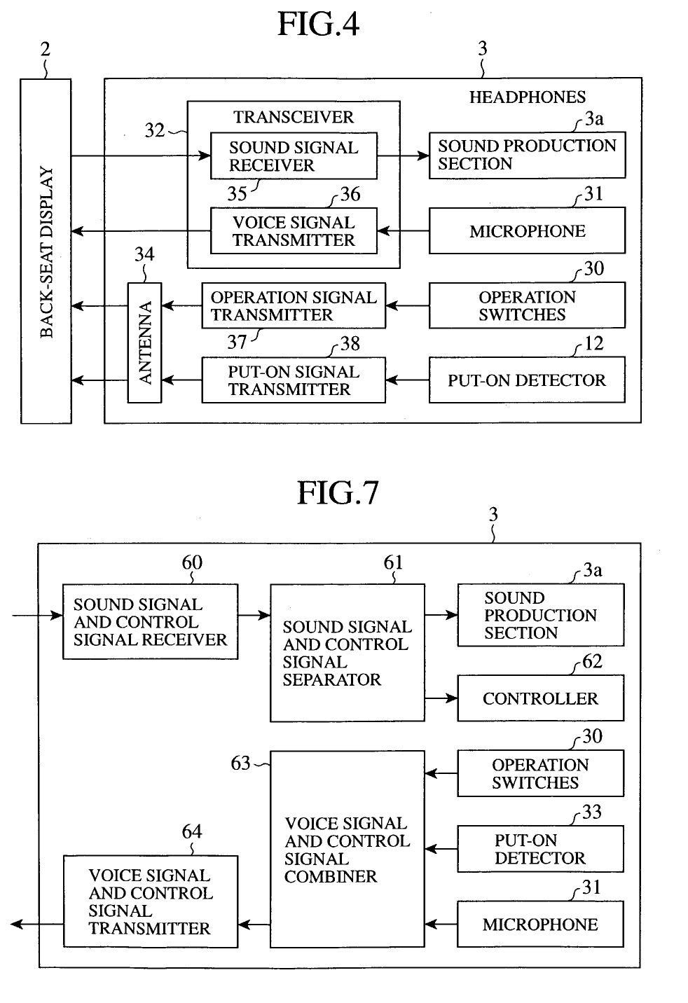

FIG. 4 is a block diagram showing a configuration of the headphones 3. The reference numeral 35 designates a sound signal receiver that constitutes the transceiver 32, and is connected to the sound production sections 3a. The reference numeral 36 designates a voice signal transmitter that also constitutes the transceiver 32, and is connected to the microphone 31. The reference numeral 37 designates an operation signal transmitter connected to the set of operation switches 30. The reference numeral 38 designates a put-on signal transmitter connected to the put-on detector 12. The operation signal transmitter 37 and put-on signal transmitter 38 are each connected to the antenna 34.

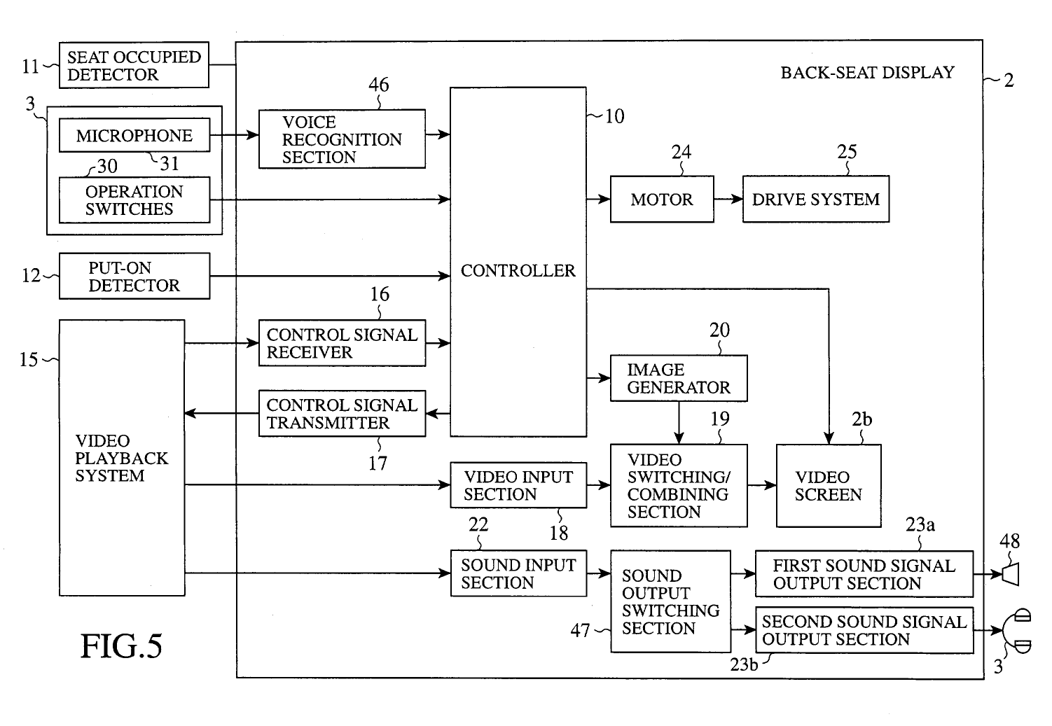

FIG. 5 is a block diagram showing a configuration of the back-seat display 2 of the present embodiment 2.

In the present embodiment 2, the controller 10 is supplied not only with the voice signal detected by the microphone 31 of the headphones 3 via a voice recognition section 46, but also with the signals output from the set of the operation switches 30. The reference numeral 47 designates a sound output switching section connected to the output of the sound input section 22 for switching the sound between a first sound signal output section 23a for driving a speaker 48 provided in the vehicle as standard equipment and a second sound output section 23b for driving the headphones 3. The remaining configuration of FIG. 5 is the same as that of FIG. 2.

Next, the operation of the present embodiment 2 will be described.

The put-on detector 12 detects that the passenger 6 wears the headphones 3 when he or she puts on them after sitting on the back seat 1. When the user operates one of the operation switches 30, the signal is transmitted to the back-seat display 2 via the antenna 34. The operation of the operation switches 30 enables the user to switch the playback images on the back-seat display 2 (between TV and DVD, for example), to switch the channels of the TV, to control the brightness, contrast and volume of the TV, and to set or adjust other characteristics of the back-seat display 2.

The passenger 6 can also issue a command to the controller 10 to automatically adjust the screen 2b at the optimum angle and position in response to the voice signal sent from the microphone 31. For example, a command such as “right”, “left”, “up” and “down” by voice causes the controller 10 to control the motor 24 that drives the drive system 25 of the back-seat display 2 to adjust the angle and position of the screen 2b. The user can also control the brightness, contrast and the like of the images on the screen of the screen 2b by controlling the video switching/combining section 19 by voice as needed.

Embodiment 3

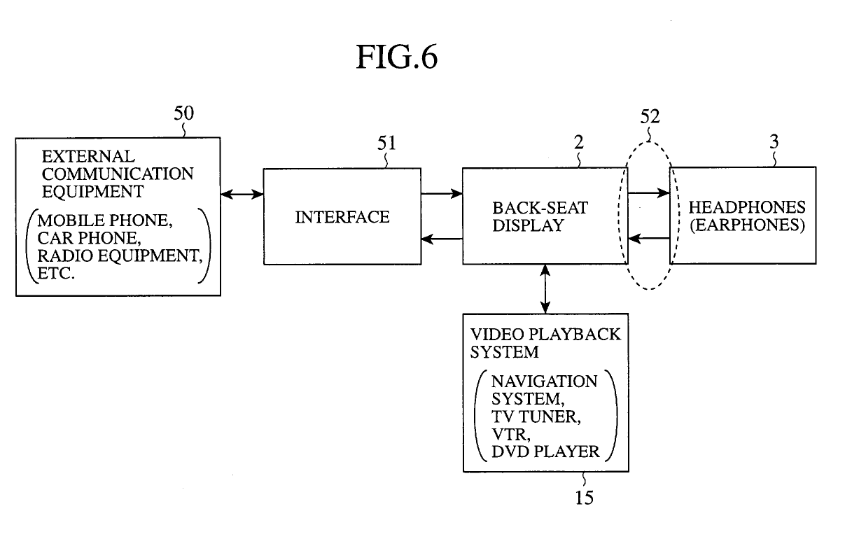

FIGS. 6-8 are block diagrams showing an embodiment 3 of the information playback apparatus in accordance with the present invention.

FIG. 6 is a block diagram showing a configuration of a back-seat video apparatus of the vehicle. In FIG. 6, the reference numeral 50 designates external communication equipment such as a mobile phone, car phone and other radio equipment, and 51 designates an interface for connecting the external communication equipment 50 with the back-seat display 2. The back-seat display 2 is connected to the headphones 3 via a wired or wireless communication means 52 utilizing light, infrared rays, radio waves or Bluetooth.

FIG. 7 is a block diagram showing a configuration of the headphones 3. In FIG. 7, the reference numeral 60 designates a sound signal and control signal receiver connected to the sound production sections 3a and controller 62a via a sound signal and control signal separator 61 for separating the sound signal from the control signal. The reference numeral 63 designates a voice signal and control signal combiner for combining the voice signal and the control signal, and 64 designates a voice signal and control signal transmitter.

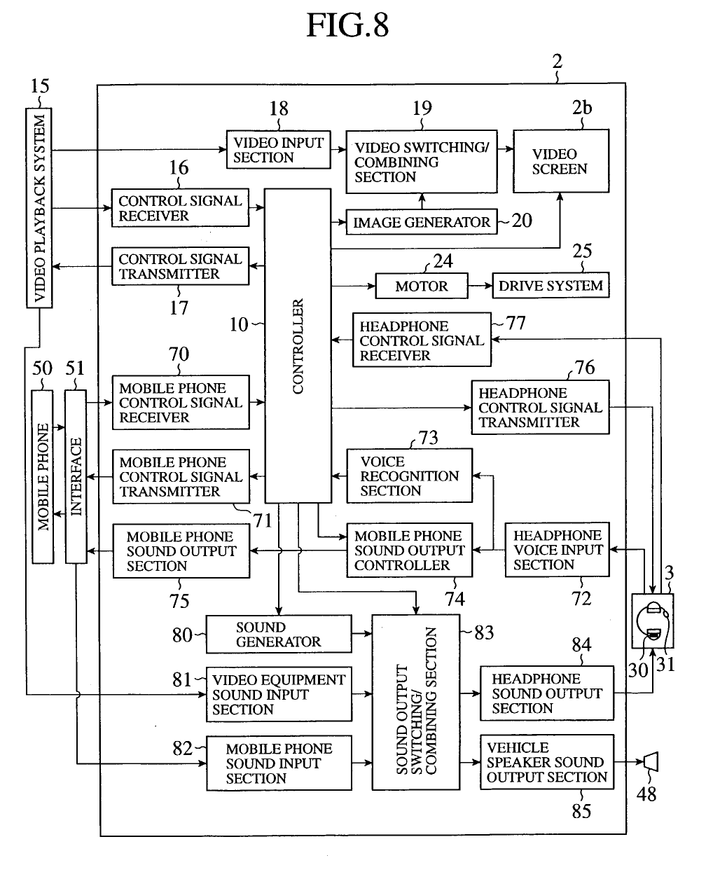

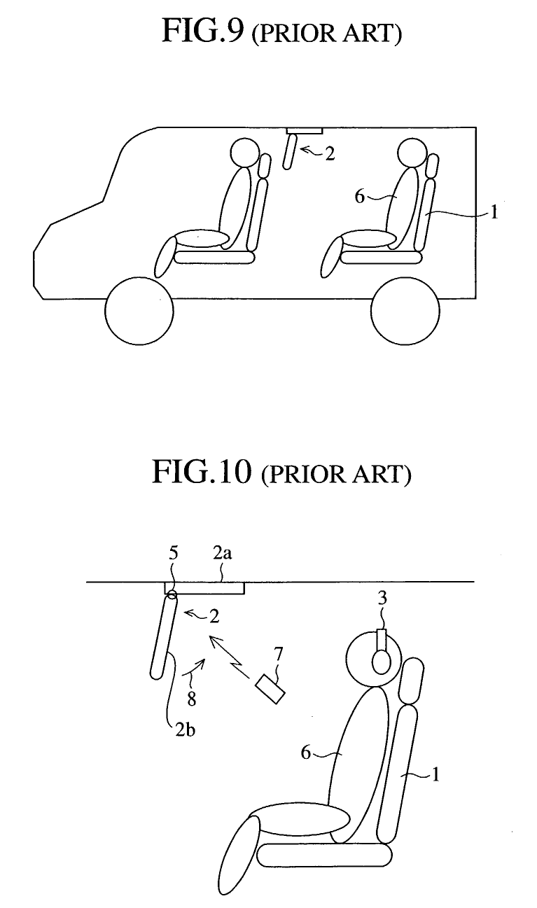

FIG. 8 is a block diagram showing a configuration of the back-seat display 2 of the present embodiment 3. In FIG. 2, the same reference numerals as those of FIG. 5 designate the same or like portions.

The reference numeral 70 designates a mobile phone control signal receiver; 71 designates a mobile phone control signal transmitter; 72 designates a headphone voice input section for receiving voice from the microphone 31 attached to the headphones 3; 73 designates a voice recognition section; 74 designates a mobile phone sound output controller; 75 designates a mobile phone sound output section; 76 designates a headphone control signal transmitter; and 77 designates a headphone control signal receiver. The reference numeral 80 designates a sound generator; 81 designates a video equipment sound input section; 82 designates a mobile phone sound input section; 83 designates a sound output switching/combining section; 84 designates a headphone sound output section; and 85 designates a vehicle speaker sound output section.

Next, the operation of the present embodiment 3 will be described.

(a) Detection of Incoming Call to Mobile Phone

It is likely that the passenger 6 is unaware of an incoming call to the mobile phone (or car phone or wireless phone; the mobile phone will be used as an example in the following description), when he is watching TV or DVD program on the back-seat display 2 with wearing the headphones 3. In view of this, the present embodiment 3 is configured such that the mobile phone control signal receiver 70 detects the incoming call to the mobile phone via the interface 51, and sends the information to the controller 10 so that the controller causes the sound of the headphones 3 to be switched to the ringer tone via the sound generator 80, sound output switching/combining section 83 and headphone sound output section 84. It is also possible to notify the passenger of the incoming call by displaying a message on the screen 2b of the back-seat display 2 in response to a command from the controller 10. Thus, the passenger can become aware of the incoming call to the mobile phone without fail.

(b) Handsfree Telephone Conversation

When the passenger 6 selects the incoming call to the mobile phone by the voice input through the microphone 31 attached to the headphones 3 or by using one of the operation switches 30, the controller 10 halts the playback by the DVD player or the like, and automatically switches the sound of the headphones to the phone call in response to the signal from the headphone voice input section 72, thereby enabling the passenger 6 to make telephone conversation through the microphone 31. The passenger can terminate the telephone conversation in the same manner by means of voice or operation of one of the operation switches 30. Then, the controller 10 automatically returns the back-seat display 2 to the state before the telephone conversation.

(c) Detection of E-mail

When the mobile phone control signal receiver 70 detects the arrival of an E-mail at the mobile phone, the controller 10 causes the headphone sound output section 84 to switch the sound of the headphones 3 to the sound of the E-mail incoming call, and causes the screen 2b to notify the passenger of the E-mail arrival by displaying a massage as needed. Thus, the passenger can become aware of the E-mail arrival at the mobile phone without fail.

(d) E-mail Operation

When the E-mail arrival is detected in (c) above, the passenger carries out the E-mail operation such as reading it, editing it and transmitting a reply using the voice recognition via the microphone 31 or the operation of one of the operation switches 30. The back-seat display 2 displays a message corresponding to the operation on its screen 2b. In addition, when the E-mail includes a still or moving picture, the back-seat display 2 shows it on the screen 2b. This can save the passenger from having to confirm the E-mail or transmit a reply on the mobile phone every time the E-mail arrives.

(e) Internet Operation

The passenger carries out the Internet operation such as reading, editing and transmitting an Internet message using the voice recognition via the microphone 31 or the operation of one of the operation switches 30. The back-seat display 2 displays a message corresponding to the operation on its screen 2b. As for voice data or the like, the sound generator 80 generates the sound corresponding to the data, thereby enabling the headphones 3 or speaker 48 to reproduce the sound data. Thus, the passenger can carry out the Internet operation using the headphones 3.

Although the information playback apparatus is applied to the back-seat display 2 on the vehicle in the foregoing embodiments, this is not essential. For example, it is also applicable to all the cases where a user wears the headphones 3 (or earphones) to enjoy a video and/or sound program on other mobile unit or in the outside.

What is claimed is:

1. An information playback apparatus comprising:
information playback means for playing back information;
video display means for displaying images in response to information played back by said information playback means;
sound output means for outputting sound in response to the information played back by said information playback means; and
put-on detection means for detecting wearing of said sound output means by a user, and for outputting a put-on detection signal, wherein
said information playback means starts playback of the information in response to the put-on detection signal.

2. The information playback apparatus according to claim 1, further comprising:
open/close means for opening and closing the screen of said video display means; and
control means for controlling said open/close means in response to the put-on detection signal.

3. The information playback apparatus according to claim 1, further comprising:
voice input means for inputting voice of the user;
voice recognition means for recognizing the voice supplied from said voice input means; and
control means for providing instructions for said information playback means to carry out specified operation in response to a control signal from said voice recognition means.

4. The information playback apparatus according to claim 1, further comprising external communication means for communicating with outside.

5. The information playback apparatus according to claim 4, wherein said external communication means consists of one of a mobile phone, car phone and other radio equipment.

6. The information playback apparatus according to claim 4, further comprising means for displaying contents of an incoming call via said external communication means on said video display means.

7. The information playback apparatus according to claim 4, further comprising:
means for detecting arrival of an E-mail at said external communication means;
means for switching sound of said sound output means to a ringer tone of the E-mail; and
means for displaying an incoming message of the E-mail on said video display means.

8. The information playback apparatus according to claim 1, further comprising:
seat occupied detection means for detecting taking a seat of the user, and for outputting a seat occupied detection signal;
open/close means for opening and closing the screen of said video display means; and
control means for controlling said open/close means in response to the seat occupied detection signal.

9. The information playback apparatus according to claim 8, further comprising:
driving means for rotating and moving the screen of said video display means, wherein
said seat occupied detection means comprises means for detecting a sitting position of a user, and for outputting a sitting position detection signal, and
said control means controls said driving means in response to the sitting position detection signal to adjust an angle and position of the screen.

10. The information playback apparatus according to claim 1, further comprising:
a viewpoint detector for detecting a point of view of the user, and for outputting a viewpoint detection signal;
driving means for rotating and moving the screen of said video display means; and
control means for controlling said driving means in response to the viewpoint detection signal to automatically adjust at least one of an angle and position of the screen, and brightness and contrast of images on the screen.

11. The information playback apparatus according to claim 1, wherein said sound output means comprises:
a set of operation switches for carrying out as least one of selecting type of information to be reproduced by said information playback means, making channel switching, adjusting brightness and contrast of images on the screen of said video display means, and controlling volume of said sound output means.

12. The information playback apparatus according to claim 1, wherein said information playback apparatus is mounted on a mobile unit, and wherein said sound output means consists of headphones or earphones.

13. An information playback method comprising the steps of:
playing back information;
displaying image associated with played back information on a screen;
outputting sound associated with played back information from sound output means;
detecting putting on of said sound output means by a user and outputting a detection signal; and
starting playback of the information in response to the detection signal.
